(19) United States
(12) Patent Application Publication
(10) Pub. No.: US 2007/0300225 A1
(43) Pub. Date: Dec. 27, 2007

(54) PROVIDING USER INFORMATION TO INTROSPECTION

(75) Inventors: Steven W. Macbeth, Snohomish, WA (US); Roland L. Fernandez, Woodinville, WA (US); Brian R. Meyers, Issaquah, WA (US); Desney S. Tan, Kirkland, WA (US); George G. Robertson, Seattle, WA (US); Nuria M. Oliver, Seattle, WA (US); Oscar E. Murillo, Seattle, WA (US); Elin R. Pedersen, Seattle, WA (US); Mary P. Czerwinski, Woodinville, WA (US); Jeanine E. Spence, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Coporation, Redmond, WA (US)

(21) Appl. No.: 11/426,830

(22) Filed: Jun. 27, 2006

(51) Int. Cl. G06F 9/46

(52) U.S. Cl. 718/100

(57) ABSTRACT

User introspection is provided to help users achieve goals (e.g., work goals, personal goals) and become more effective at performing tasks. Activities can be monitored, logged, and compared to a set of goals or tasks. Feedback can be provided if a user has deviated from a specified goal or task, in the form of a recommendation as to a next action, or based upon user-defined criteria. Feedback can also be provided based on a multitude of parameters that can include prioritized goal definition and refinement, task avoidance behavior detection, baseline activity analysis (e.g. historical data), base-line capacity (personal and/or comparison to others), task reacquisition, etc.

### CROSS-REFERENCE TO RELATED APPLICATIONS

This application is related to U.S. patent application Ser. No. ______ (Attorney Docket Number MS315859.01/MSFTP1290US) filed on Jun. 27, 2006, entitled “LOGGING USER ACTIONS WITHIN ACTIVITY CONTEXT′”Ser. No. ______ (Attorney Docket Number MS315860.01/MSFTP1291US) filed on Jun. 27, 2006, entitled “RESOURCE AVAILABILITY FOR USER ACTIVITIES ACROSS DEVICES′” Ser. No. ______ (Attorney Docket Number MS315861.01/MSFTP1292US) filed on Jun. 27, 2006, entitled “CAPTURE OF PROCESS KNOWLEDGE FOR USER ACTIVITIES”; Ser. No. ______ (Attorney Docket Number MS315863.01/MSFTP1294US) filed on Jun. 27, 2006, entitled “MONITORING GROUP ACTIVITIES”; Ser. No. ______ (Attorney Docket Number MS315864.01/MSFTP1295US) filed on Jun. 27, 2006, entitled “MANAGING ACTIVITY-CENTRIC ENVIRONMENTS VIA USER PROFILES”; Ser. No. ______ (Attorney Docket Number MS315865.01/MSFTP1296US) filed on Jun. 27, 2006, entitled “CREATING AND MANAGING ACTIVITY-CENTRIC WORKFLOW”; Ser. No. ______ (Attorney Docket Number MS315866.01/MSFTP1297US) filed on Jun. 27, 2006, entitled “ACTIVITY-CENTRIC ADAPTIVE USER INTERFACE”; Ser. No. ______ (Attorney Docket Number MS315867.01/MSFTP1298US) filed on Jun. 27, 2006, entitled “ACTIVITY-CENTRIC DOMAIN SCOPING”; and Ser. No. ______ (Attorney Docket Number MS315868.01/MSFTP1299US) filed on Jun. 27, 2006, entitled “ACTIVITY-CENTRIC GRANULAR APPLICATION FUNCTIONALITY”. The entirety of each of the above applications are incorporated herein by reference.

### BACKGROUND

Conventionally, communications between humans and machines have not been natural. Human-human communication typically involves spoken language combined with hand and facial gestures or expressions, and with the humans understanding the context of the communication. Human-machine communication is typically much more constrained, with devices like keyboards and mice for input, and symbolic or iconic images on a display for output, and with the machine understanding very little of the context. For example, although communication mechanisms (e.g., speech recognition systems) continue to develop, these systems do not automatically adapt to the activity of a user. As well, traditional systems do not consider contextual factors (e.g., user state, application state, environment conditions) to improve communications and interactivity between humans and machines.

Activity-centric concepts are generally directed to ways to make interaction with computers more efficient (by providing some additional context for the communication). Traditionally, computer interaction centers around one of three pivots, 1) document-centric, 2) application-centric, and 3) device-centric. However, most conventional systems cannot operate upon more than one pivot simultaneously, and those that can do not provide much assistance managing the pivots. Hence, users are burdened with the tedious task of managing every little aspect of their tasks/activities.

A document-centric system refers to a system where a user first locates and opens a desired data file before being able to work with it. Similarly, conventional application-centric systems refer to first locating a desired application, then opening and/or creating a file or document using the desired application. Finally, a device-centric system refers to first choosing a device for a specific activity and then finding the desired application and/or document and subsequently working with the application and/or document with the chosen device.

Accordingly, since the traditional computer currently has little or no notion of activity built in to it, users are provided little direct support for translating the “real world” activity they are trying to use the computer to accomplish and the steps, resources and applications necessary on the computer to accomplish the “real world” activity. Thus, users traditionally have to assemble “activities” manually using the existing pieces (e.g., across documents, applications, and devices). As well, once users manually assemble these pieces into activities, they need to manage this list mentally, as there is little or no support for managing this on current systems.

The activity-centric concept is based upon the notion that users are leveraging a computer to complete some real world activity. Historically, a user has had to outline and prioritize the steps or actions necessary to complete a particular activity mentally before starting to work on that activity on the computer. Conventional systems do not provide for systems that enable the identification and decomposition of actions necessary to complete an activity. In other words, there is currently no integrated mechanism available that can dynamically understand what activity is taking place as well as what steps or actions are necessary to complete the activity.

Most often, the conventional computer system has used the desktop metaphor, where there was only one desktop. Moreover, these systems stored documents in a single filing cabinet. As the complexity of activities rises, and as the similarity of the activities diverges, this structure does not offer user-friendly access to necessary resources for a particular activity.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its sole purpose is to present some concepts of the described embodiments in a simplified form as a prelude to the more detailed description that is presented later.

The innovation can monitor and log one or more user activities and provide visualization of log data, which allows a user to manipulate their log data. Such visualization allows a user to inspect their behavior and derive useful information, which can be used in a self-improvement process.

The innovation can also provide feedback to the user. Such feedback can be in the form of a recommendation as to a next action (e.g., task) that should be performed based on various parameters associated with the one or more activities. The parameters can include prioritized goal definition and refinement, task avoidance behavior detection, thrashing behavior, base line activity analysis (e.g., historical data), base-line capacity (personal and/or comparison to others), task reacquisition, etc. Such recommendations can be provided automatically or upon a user request.

A user profile, an activity profile, and/or device profile can be employed to effectuate the next action recommendation. Such profiles can be combined with calendar events, historical activity data, environmental conditions, physiological conditions, and the like.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates an activity centric system that can provide a user with an unstructured introspection through visualization and manipulation functions.

FIG. 2 illustrates an activity centric system that can provide structured feedback.

FIG. 3 illustrates a system that facilitates goal accomplishment through task reacquisition or goal reminder.

FIG. 4 illustrates an overall activity-centric system in accordance with the one or more embodiments.

FIG. 5 illustrates a methodology for providing a user with performance feedback.

FIG. 6 illustrates a methodology for providing goal deviation information to a user to align a user activity with a defined goal.

FIG. 7 illustrates a methodology for facilitating resumption or the start of a task.

FIG. 8 illustrates a block diagram of a computer operable to execute the disclosed embodiments.

FIG. 9 illustrates a schematic block diagram of an exemplary computing environment operable to execute the disclosed embodiments.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component”, “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

As used herein, the terms to “infer” or “inference” refer generally to the process of reasoning about or inferring states of the system, environment, and/or user from a set of observations as captured through events, sensors, and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

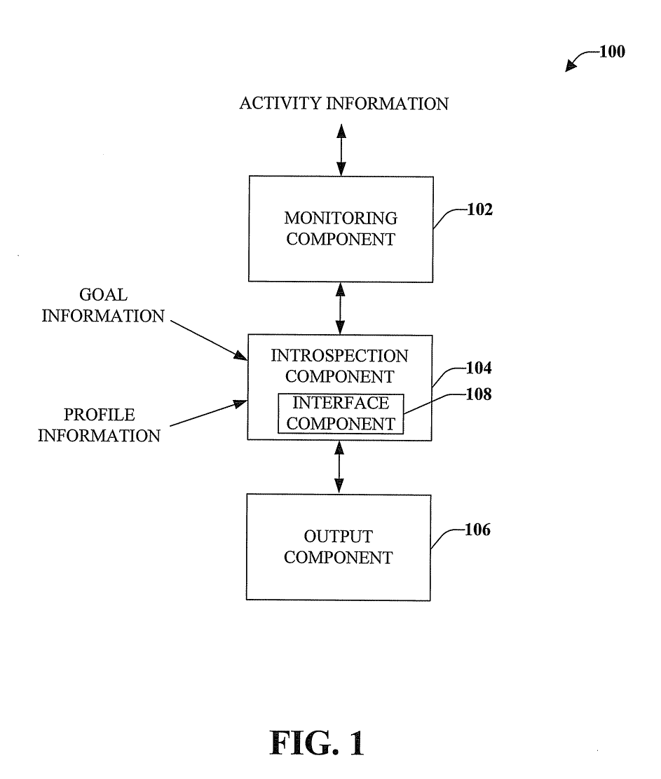

Referring initially to FIG. 1, illustrated is an activity centric system 100 that can provide a user with an unstructured introspection through visualization and manipulation functions. System 100 can help users achieve their goals and become more effective at their jobs and can extend outside the workplace to also help the user balance life goals (e.g., diet, exercise, socializing, education, community service, and so on) by comparing logged activities against a set of goals.

System 100 can include a monitoring component 102, an introspection component 104, and an output component 106. The monitoring component 102 can be configured to monitor and log activity information. Activity information can include tasks that the user is performing or has completed, regardless of whether such tasks relate to a defined goal. The activity information can be logged for historical analysis or data manipulation.

Introspection component 104 can be configured to receive and record user-defined goal(s) (e.g., a task to be completed, an exercise schedule, community activities, . . . ). Based on the activity information from monitoring component 102 and the goal information, introspection component 104 can analyze the data and provide various types of information to the user in regard to the goals and progress relating to completion of the goals.

In combination with the activity logging are user profiles, activity profiles, organizational profiles and device profiles that can form a basis for the analyzed (manually or automated) data. Introspection component 104 can be configured to provide a comparison between the activity and a stated goal based at least in part on the monitored activity. Together these components (102, 104) can facilitate recording and monitoring of data in the context of activities the user is performing and those activities the user should be performing.

Introspection component 104 can include an interface component 108 that allows a user access into a database of logged activities. Various types of information can be provided from a manual reporting perspective and can also be built into an automated perspective. There is also an ad hoc capability that allows the user to manipulate the data in unique ways. This allows the user to configure various queries, manipulate the data, and view it in a multitude of different ways. A few areas where users can participate in an ad hoc manner include changing the system 100 analysis performed on the data and making a new analysis on the data. For example, a user may wish to view only all communication activities (e.g., e-mail, instant messaging, etc.) in order to determine how much time such user is spending communicating information with other people. Alternatively, the user may wish to sort the list(s) based on specific people or roles (e.g., work-based versus social communication).

The interface component 108 can provide a graphical user interface (GUI), a command line interface, a speech interface, Natural Language text interface, and the like. For example, a GUI can be rendered that provides a user with a region or means to load, import, select, read, etc. the one or more goals, tasks, profiles, etc. and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

The user can also interact with the regions to select and provide information through various devices such as a mouse, a roller ball, a keypad, a keyboard, a pen, gestures captured with a camera and/or voice activation, for example. Typically, a mechanism such as a push button or the enter key on the keyboard can be employed subsequent to entering the information in order to initiate information conveyance. However, it is to be appreciated that the disclosed embodiments are not so limited. For example, merely highlighting a check box can initiate information conveyance. In another example, a command line interface can be employed. For example, the command line interface can prompt the user for information by providing a text message, producing an audio tone, and the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

Introspection component can interface with output component 106 to provide real-time feedback and/or a reporting mechanism (in the form of feedback) to assist the user in understanding how time is being spent. The reporting can provide information regarding what tasks a user has performed as well as how the user's goals are tied into those activities, including information about how ‘on target’ the user was. Manual reporting can include a user reviewing a work style report that compares time spent on low priority items versus high priority items, for example. Reporting can also include the impact of interruptions and/or the impact of the user performing tasks in a different priority than that recommended by the system 100. Such reporting can also indicate various distractions that can lead to slower completion of a particular activity (e.g., reading email, answering the phone). Reporting can also assist the user by identifying time spent on items that are not goal related. For example, reporting can include time spent surfing the Internet or chatting in real-time (e.g., Instant Messenger type service), talking on the phone, and the like.

The user can select from a set of user profiles (e.g. sales, marketing, product development, research) and based on the selection the system 100 can have a model of how many and which types of interruptions the user can accept and what types of activities in general are more important to the user. In addition or alternatively, there can be baselines that are taken into account by the system 100. Such baselines can include organizational roles, the user's personality type, methodologies for communication or work styles, and the like. The system 100 can also include a baseline activity analyzer that can review a user's historical behavior (e.g., amount of time spent on a particular activity) or a particular set or subset of activities and compare a current or future activity with this historical data.

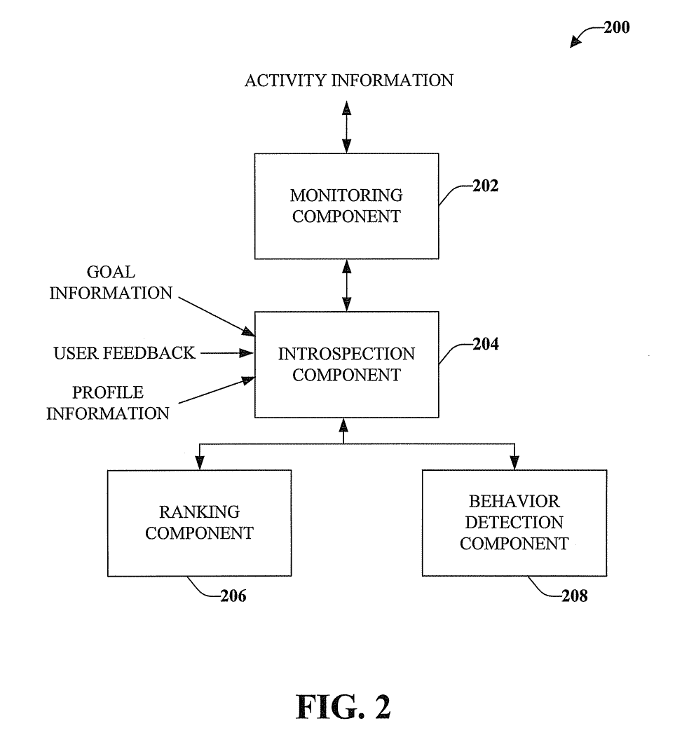

FIG. 2 illustrates an activity centric system 200 that can provide structured feedback. Such structured feedback can include recommendations that system 200 provides (e.g., next action, task avoidance guidance, thrashing behavior avoidance, and so on). System 200 includes a monitoring component 202 that can monitor one or more activity or groups of activities. Monitoring component 202 interfaces with an introspection component 204 that can provide feedback based in part on the monitored activity, or a received profile information (e.g., user profile, activity profile, organizational profile, device profile). In addition or alternatively, feedback can be provided by introspection component 204 based at least in part on one or more defined goals. Such feedback can be facilitated by introspection component 204 through an interface with a ranking component 206, a behavior detection component 208, or both components (206, 208).

A novel functionality of this innovation discloses a mechanism of determining a next best action/activity (or a next worst action/activity) based on analyzing logged data, system baselines (when appropriate), user profiles, organizational profiles (created by analyzing data logged by the user's peers), activity profiles, and/or device profiles. The activities can be ranked, by ranking component 206, based on a scale or other spectrum, while allowing the user to override the recommendations.

There are a number of ways that a goal or task ranking can be changed. The user can be provided an explicit manner of indicating that the goals or the reasoning that lead to the ordering of goals has changed and update such items manually. Another way includes the user changing the order and allowing the system 200 to infer the user intent based on the new ordering. Another way to change a goal or task rating includes the system 200 using rules to indicate the ordering and the underlying algorithm can be changed to manipulate the ranked tasks or goals.

An additional set of data that can be logged relates to task accomplishment. Task accomplishment might be inferred from the activities currently being logged. Task accomplishment could be employed to determine how quickly a task is accomplished and the characteristics that went into accomplishing that task. That set of data can be used to determine what tasks the user should work on next, based on the kind of state the user is currently in (e.g., upcoming deadlines, user's emotional and physiological state, available devices or resources).

A baseline for a given type of action/activity can be provided by system 200. Such baselines can be user focused or user independent (e.g. derived from data collected across a larger population of people), allowing the system 200 to help the user identify areas where goals are being deviated from and/or where the user's performance is changing. For example, if this is the first time a user has performed a particular activity, system 200 can notify the user of the user's work practices as compared to others (e.g., organizational profiles). The system 200 can identify training opportunities or identify items or actions that took the user substantially longer to complete as compared to the amount of time taken by others. Other data can include whether the user deviated from the process and how that deviation might have influenced the user's ability to complete the activity.

The subject innovation can provide the user a report in an attempt to convince the user that actions are being performed non-optimally and try to encourage the user to change the indicated behavior. For example, system 200 can notify the user of the tasks the user should be working on, or the order of a group of tasks. The report can provide the user an indication of a work style and recommendations for improving the work style. For example, the report can list the user's predefined goals and include reasons why the goals may not have been achieved.

Task avoidance behavior detection component 208 can be configured to take into account an activity that a user has been avoiding (e.g. procrastination). For example, the system 200 can automatically re-rank (through ranking component 206) the task being avoided with a higher priority ranking or provide insight into low priority tasks that are being completed before high priority tasks. In addition or alternatively, the system 200 can detect similarities between tasks the user seems to prefer doing and infer features of those activities that are interesting to the user. The task being avoided can then be presented to the user in the context of the inferred interesting features, thus prompting the user to complete the task.

Task avoidance behavior detection component 208, in addition or alternatively, can be configured to detect a thrashing behavior. Such behavior involves switching or alternating between two or more tasks in such a manner that there is little or no progress being made on the task or set of tasks. Such behavior can also indicate that the user may be distracted and should work on a task that requires minimal concentration or a task, which can be completed in a minimal amount of time. System 200 can recommend that time should be allocated to the low concentration task or other task as determined by system to allow the user to concentrate on task completion.

In general, goal setting and prioritization can be provided by the system 200 in the form of a work coach or personal trainer. The user can provide a listing of goals for a day or week, for example. Key drivers for goal setting can include task accomplishment, identification of goals, and how tasks and activities relate to those goals. The system 200 can periodically or continuously monitor such goals and if a deviation occurs, a warning can notify the user that the user has deviated from the goal.

Feedback can be provided to the user in various forms, such as suggesting an activity that should (or should not) be performed next. Another feedback mechanism can include a dialog with the user (e.g. questionnaire) for the user to obtain a clearer understanding of personal work habits or practices. Such feedback can be real-time feedback that can include pop-up mechanisms or reminder mechanisms that can notify a user when attention to a particular task is needed. Other feedback can include manual reporting that is provided upon request. Feedback can be provided by introspection component 204 or an output or feedback component.

The user can be presented with a list of tasks from the most appropriate to the least appropriate task. If the user decides that the order is wrong, system 200 (e.g., introspection component 204) can provide the user with an interface to change the goal or the ordering of the goals. In such a manner, the system can be corrected or refined (e.g., change one or more parameters of the analysis in order to change the ordering).

If the system 200 infers actions that the user should take, the user can provide user feedback regarding the inference made by the system 200. Such user feedback can adjust the system inference mechanisms, if needed, allowing the system 200 to improve the model of the user by including the user's feedback to a next inference. The system 200 also provides visualization tools so that the users can make their own inferences from the data.

For example, a user may have a conference call ten minutes from now. System 200 can automatically infer that user should not start an activity that should have high concentration for half an hour because the two tasks (conference call and activity) will conflict with each other. In another example, system 200 can determine that user is in a distracted mode (e.g., based on a current activity) and starting an activity that should have a high amount of user concentration should not be recommended. Thus, there can be a number of next activities that might be best for the user to perform based on a current user state. There can also be a number of next activities that would not be ideal for the user to start based on the same user state. The scale of activities that should (or should not) be performed next can be based on a scale or a ranking from best to worst, or another ranking criteria.

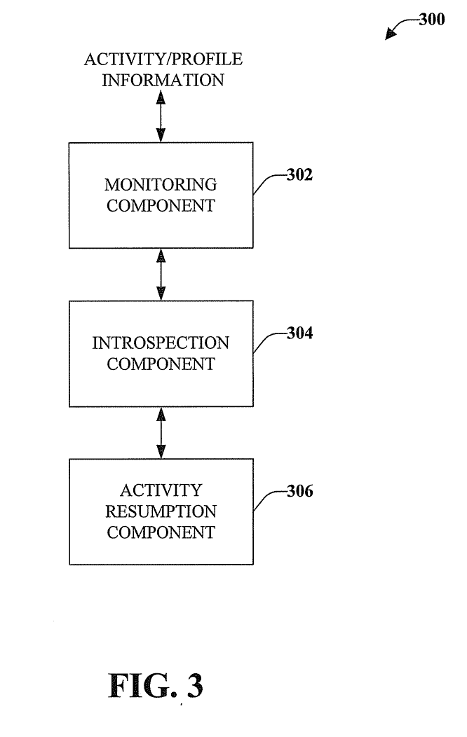

FIG. 3 illustrates a system 300 that facilitates goal accomplishment through task reacquisition or a goal reminder system. System 300 includes a monitoring component 302 that monitors one or more user activity and an introspection component 304 that provides feedback based on the monitored activities. Also included in system 300 is an activity resumption component 306 that can be configured to provide a means to facilitate task reacquisition or goal reminder.

The reminder system 300 can be activity centric so that it would remind the user a predetermined interval before a task is due of that particular activity. This interval can be based partially on the difficulty of the task, or on the expected time the task will take to complete. The activity resumption component 306 can be configured to provide the user with links or tasks to facilitate resumption of the activity. In such a manner, the system 300 provides a simple way of reminding the user of the goal and then switching the user into that activity or the state of that activity so the task can be easily resumed. In addition or alternatively, the activity resumption component 306 can remind the user of the last task(s) completed, the time already spent on the activity, the time spent on each particular portion of the task, the context for the task, why the task is important, etc. For example, a list of action items can be propagated to indicate what the user might do next. If a task has changed or there is an update, activity resumption component 306 could automatically notify the user that the task is ready and the user can switch to performing that task.

Some activities have a workflow or a sequence of steps. When a task reacquisition is performed, activity resumption component 306 can indicate a particular placement within the workflow process. This can include the steps that are finished, the steps in progress and their states (e.g., open applications, window positions, document states and the like), the next step to be performed, and the remaining steps needed to finish the task. Such information can make it easier for the user to resume the activity.

Another aspect of the innovation is the ability to reflect on how time was spent on each activity during a particular time period. This enables the semi-automatic production of time cards and status reports, which can then assist with introspection and self-management, billing, or project management.

Machine learning algorithms can also be employed with the various systems of the above figures wherein if a user continuously overrides or denies a task or the order of tasks, the system can employ such user activity to re-rank certain tasks. For example, in some instances, the user is denying a task and in other instances is accepting the tasks. The system can determine what factors are coming into play when the user is accepting the task and use those factors to re-rank the tasks. It should be noted that various other algorithms, methods, and/or techniques can be employed to re-rank certain tasks or perform other system functions. For example, a process for determining a ranking can be facilitated through an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic statistical, and or decision theoretic-based analysis (e.g., factoring into the analysis utilities and costs) to prognose or infer an action that a user desires to be automatically performed.

A support vector machine (SVM) is an example of a classifier that can be employed. The SVM operates by finding a hypersurface, which attempts to split the triggering criteria from the non-triggering events, in the space of possible inputs. Intuitively, this makes the classification correct for testing data that is near, but not identical to training data. By defining and applying a kernel function to the input data, the SVM can learn a non-linear hypersurface. Other directed and undirected model classification approaches include, e.g., naïve Bayes, Bayesian networks, decision trees, neural networks, fuzzy logic models, and other probabilistic classification models providing different patterns of independence can be employed.

As will be readily appreciated from the subject specification, the innovation can employ classifiers that are explicitly trained—supervised learning (e.g., through a generic training data) as well as implicitly trained—unsupervised or clustering—(e.g., by observing user behavior, receiving extrinsic information). For example, the parameters on an SVM are estimated through a learning or training phase. Thus, the classifier(s) can be used to automatically learn and perform a number of functions, including but not limited to determining according to a predetermined criteria a current activity as well as a next activity that should (or should not) be performed.

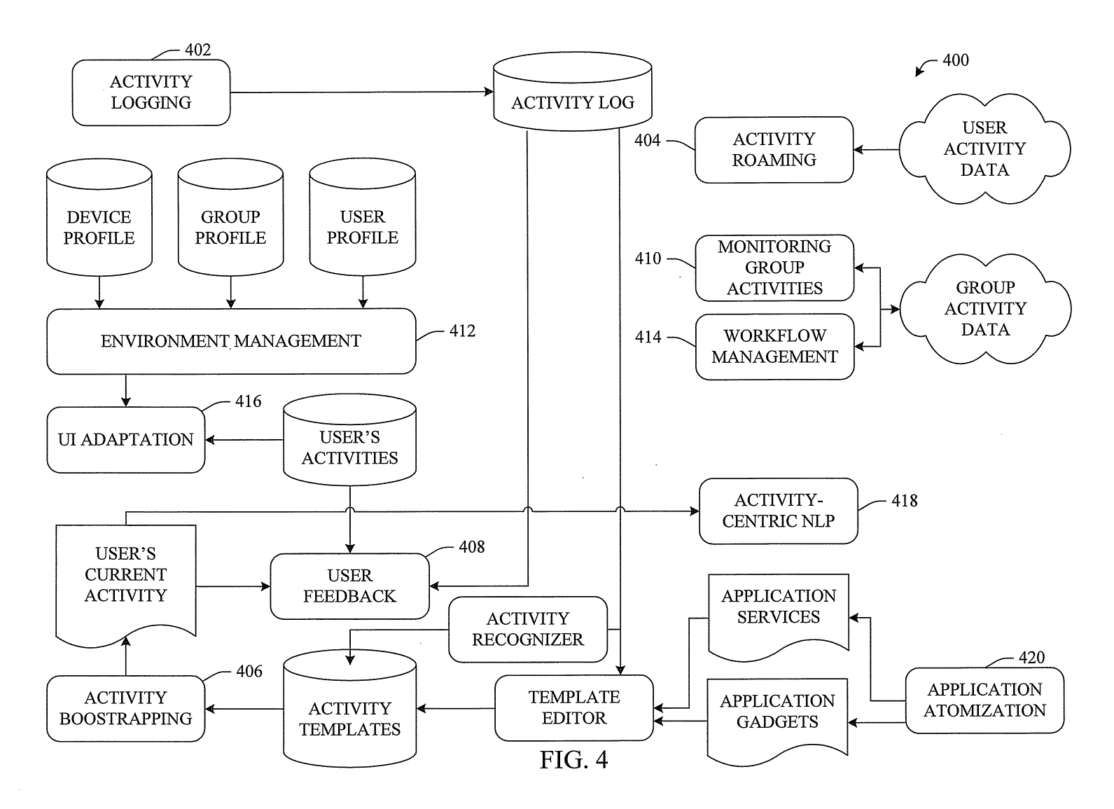

With reference now to FIG. 4, illustrated is an overall activity-centric system 400 operable to perform novel functionality described herein is shown. It is to be understood that the activity-centric system of FIG. 4 is illustrative of an exemplary system capable of performing the novel functionality of the Related Applications identified above and incorporated by reference herein. Novel aspects of each of the components of system 400 are described below.

The novel activity-centric system 400 can enable users to define and organize their work, operations and/or actions into units called “activities.” Accordingly, the system 400 offers a user experience centered on those activities, rather than pivoted based upon the applications and files of traditional systems. The activity-centric system 400 can also usually include a logging capability, which logs the user's actions for later use.

In accordance with the innovation, an activity typically includes or links to all the resources needed to perform the activity, including tasks, files, applications, web pages, people, email, and appointments. Some of the benefits of the activity-centric system 400 include easier navigation and management of resources within an activity, easier switching between activities, procedure knowledge capture and reuse, improved management of activities and people, and improved coordination among team members and between teams.

As described herein and illustrated in FIG. 4, the system 400 discloses an extended activity-centric system. However, the particular innovation (e.g. user feedback for activity-centric introspection) disclosed herein is part of the larger, extended activity-centric system 400. An overview of this extended system 400 follows.

The “activity logging” component 402 can log the user's actions on a device to a local (or remote) data store. By way of example, these actions can include, but are not limited to include, resources opened, files changed, application actions, and the like. As well, the activity logging component 402 can also log current activity and other related information. This data can be transferred to a server that holds the user's aggregated log information from all devices used. The logged data can later be used by the activity system in a variety of ways.

The “activity roaming” component 404 is responsible for storing each of the user's activities, including related resources and the “state” of open applications, on a server and making them available to the device(s) that the user is currently using. As well, the resources can be made available for use on devices that the user will use in the future or has used in the past. The activity roaming component 404 can accept activity data updates from devices and synchronize and/or collaborate them with the server data.

The “activity boot-strapping” component 406 can define the schema of an activity. In other words, the activity boot-strapping component 406 can define the types of items it can contain. As well, the component 406 can define how activity templates can be manually designed and authored. Further, the component 406 can support the automatic generation, and tuning of templates and allow users to start new activities using templates. Moreover, the component 406 is also responsible for template subscriptions, where changes to a template are replicated among all activities using that template.

The “user feedback” component 408 can use information from the activity log to provide the user with feedback on his activity progress. The feedback can be based upon comparing the user's current progress to a variety of sources, including previous performances of this or similar activities (using past activity log data) as well as to “standard” performance data published within related activity templates.

The “monitoring group activities” component 410 can use the log data and user profiles from one or more groups of users for a variety of benefits, including, but not limited to, finding experts in specific knowledge areas or activities, finding users that are having problems completing their activities, identifying activity dependencies and associated problems, and enhanced coordination of work among users through increased peer activity awareness.

The “environment management” component 412 can be responsible for knowing where the user is, the devices that are physically close to the user (and their capabilities), and helping the user select the devices used for the current activity. The component 412 is also responsible for knowing which remote devices might be appropriate to use with the current activity (e.g., for processing needs or printing).

The “workflow management” component 414 can be responsible for management and transfer of work items that involve other users or asynchronous services. The assignment/transfer of work items can be ad-hoc, for example, when a user decides to mail a document to another user for review. Alternatively, the assignment/transfer of work items can be structured, for example, where the transfer of work is governed by a set of pre-authored rules. In addition, the workflow manager 414 can maintain an “activity state” for workflow-capable activities. This state can describe the status of each item in the activity, for example, which it is assigned to, where the latest version of the item is, and so on.

The “UI adaptation” component 416 can support changing the “shape” of the user's desktop and applications according to the current activity, the available devices, and the user's skills, knowledge, preferences, policies, and various other factors. The contents and appearance of the user's desktop, for example, the applications, resources, windows, and gadgets that are shown, can be controlled by associated information within the current activity. Additionally, applications can query the current activity, the current “step” within the activity, and other user and environment factors, to change their shape and expose or hide specific controls, editors, menus, and other interface elements that comprise the application's user experience.

The “activity-centric recognition” component or “activity-centric natural language processing (NLP) component 418 can expose information about the current activity, as well as user profile and environment information in order to supply context in a standardized format that can help improve the recognition performance of various technologies, including speech recognition, natural language recognition, optical character recognition, handwriting recognition, gesture recognition, desktop search, and web search.

Finally, the “application atomization” component 420 represents tools and runtime to support the designing of new applications that consist of services and gadgets. This enables more fine-grained UI adaptation, in terms of template-defined desktops, as well as adapting applications. The services and gadgets designed by these tools can include optional rich behaviors, which allow them to be accessed by users on thin clients, but deliver richer experiences for users on devices with additional capabilities.

In accordance with the activity-centric environment 400, once the computer understands the activity, it can adapt to that activity. For example, if the activity is the review of a multi-media presentation, the application can display the information differently as opposed to an activity of the UI employed in creating a multi-media presentation. The computer can react and tailor functionality and the UI characteristics based upon a current state and/or activity. The system 400 can understand how to bundle up the work based upon a particular activity. Additionally, the system 400 can monitor actions and automatically bundle them up into an appropriate activity or group of activities. The computer will also be able to associate a particular user to a particular activity, thereby further personalizing the user experience.

In summary, the activity-centric concept of the subject system 400 is based upon the notion that users can leverage a computer to complete some real world activity. As described above, historically, a user would outline and prioritize the steps or actions necessary to complete a particular activity mentally before starting to work on that activity on the computer. In other words, conventional systems do not provide for systems that enable the identification and decomposition of actions necessary to complete an activity.

The novel activity-centric systems enable automating knowledge capture and leveraging the knowledge with respect to previously completed activities. In other words, in one aspect, once an activity is completed, the subject innovation can infer and remember what steps were necessary when completing the activity. Thus, when a similar or related activity is commenced, the activity-centric system can leverage this knowledge by automating some or all of the steps necessary to complete the activity. Similarly, the system could identify the individuals related to an activity, steps necessary to complete an activity, documents necessary to complete, and so forth. Thus, a context can be established that can help to complete the activity next time it is necessary to complete. As well, the knowledge of the activity that has been captured can be shared with other users that require that knowledge to complete the same or a similar activity.

Historically, the computer has used the desktop metaphor, where there was effectively only one desktop. Moreover, conventional systems stored documents in a filing cabinet, where there was only one filing cabinet. As the complexity of activities rises, and as the similarity of the activities diverges, it can be useful to have many desktops available that can utilize identification of these similarities in order to streamline activities. Each individual desktop can be designed to achieve a particular activity. It is a novel feature of the innovation to build this activity-centric infrastructure into the operating system such that every activity developer and user can benefit from the overall infrastructure.

The activity-centric system proposed herein is made up of a number of components as illustrated in FIG. 4. It is the combination and interaction of these components that compromises an activity-centric computing environment and facilitates the specific novel functionality described herein. At the lowest level the following components make up the core infrastructure that is needed to support the activity-centric computing environment; Logging application/user actions within the context of activities, User profiles and activity-centric environments, Activity-centric adaptive user interfaces, Resource availability for user activities across multiple devices and Granular applications/web-services functionality factoring around user activities. Leveraging these core capabilities with a number of higher-level functions are possible, including; providing user information to introspection, creating and managing workflow around user activities, capturing ad-hoc and authored process and technique knowledge for user activities, improving natural language and speech processing by activity scoping, and monitoring group activity.

The exemplary systems shown and described above will be better appreciated with reference to the methodologies of the following figures. While, for purposes of simplicity of explanation, the one or more methodologies shown herein, e.g. in the form of a flow chart, are shown and described as a series of acts, it is to be understood and appreciated that the subject embodiments are not limited by the order of acts, as some acts may, in accordance with the embodiments, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

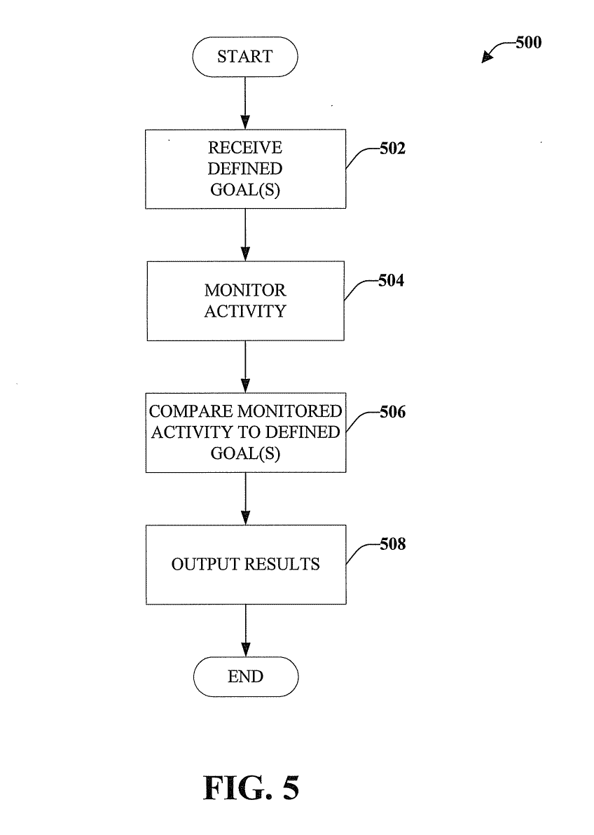

FIG. 5 illustrates a methodology 500 for providing a user with performance feedback. Method 500 starts, at 502, where defined goal(s) are received. Such goal(s) can relate to any activity or a group of activities and can further include individual tasks that should be performed to achieve the goal. The actual activities performed are monitored, at 504. Such monitoring can include logging of the activities in a readily retrievable format.

At 506, the monitored activity is compared to the defined goal(s). Such comparison can be made to determine whether the user is on target (or off target) in relation to the goals. A result of the comparison is output or presented to user, at 508. Such output can be real-time feedback to indicate how well the user is accomplishing the defined goals (or if the user is not accomplishing the goals). The output can also be provided based on a user specified query.

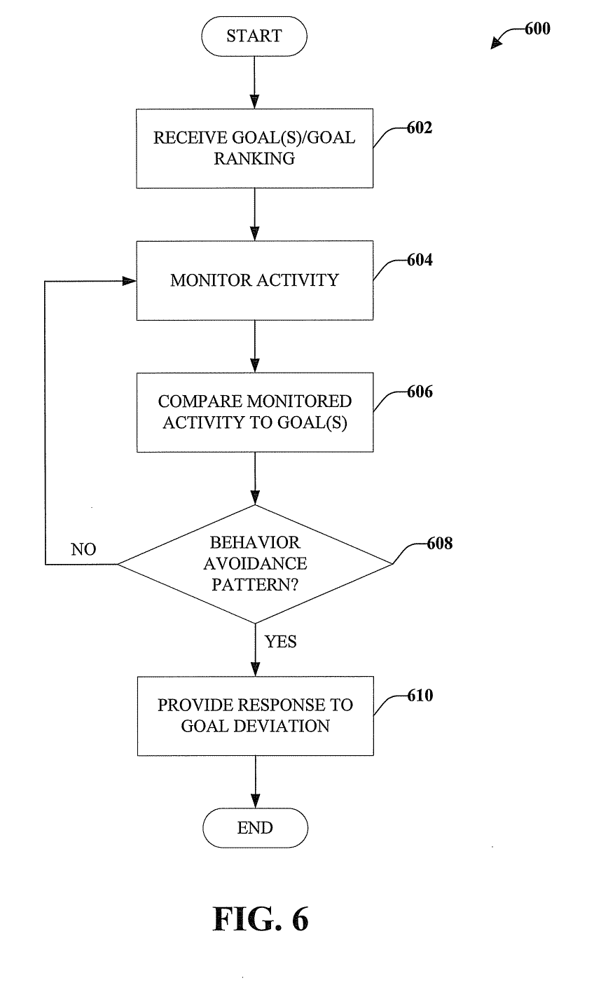

FIG. 6 illustrates a methodology 600 for providing goal deviation information to a user to align a user activity with a defined goal. At 602, one or more goals are received. Also received can be a goal ranking or priority listing based on various criteria (e.g., importance of a task (goal), due date of a task, and so on). At 604, monitoring of activities is performed. An activity or group of activities can also be logged and such logging can include task information, task completion time, as well as other information that would be useful to monitor and improve task completion performance. The monitored activity is compared to the goals, at 606.

A determination is made, at 608, whether there is a behavior pattern of avoidance. Such a pattern can be detected, for example, by a user disregarding a particular task for a determined length of time (e.g., not completing a task within two weeks of a due date) or completing low-priority or low-ranked tasks before completion of a high-priority or high-ranked tasks. If there is no behavior avoidance pattern detected, at 608, the method 600 can return to 604 with activity monitoring.

In addition or alternatively, at 608, a determine can be made whether the user is exhibiting a thrashing behavior. Thrashing involves the user switching between tasks in such a manner that there is little or no progress being made on the tasks. The switching can occur rapidly (e.g. every few minutes) and can involve switching between two or more tasks. If thrashing behavior is involved, it might be more advantageous for the user to allocate more time to a particular task or set of tasks

If a behavior avoidance pattern is detected, at 610, a response is provided with respect to the goal deviation. Such a response can include re-ranking the avoided task, so that such task has a perceived higher ranking or priority. In addition or alternatively, the response can include detecting similarities between tasks the user seems to prefer doing and infer features of those activities that are interesting to the user. The task being avoided can then be presented to the user in the context of the inferred interesting features, thus prompting the user to complete the task. If thrashing behavior is detected, at 608, the user might be provided with a recommendation to allocate the next period of time (e.g., 30 minutes, 1 hour) to a particular task or set of tasks to complete such tasks, rather than switching back and forth between tasks. The method 600 can return to 604 for activity monitoring or to 602 with new or modified goals(s) and/or ranking(s).

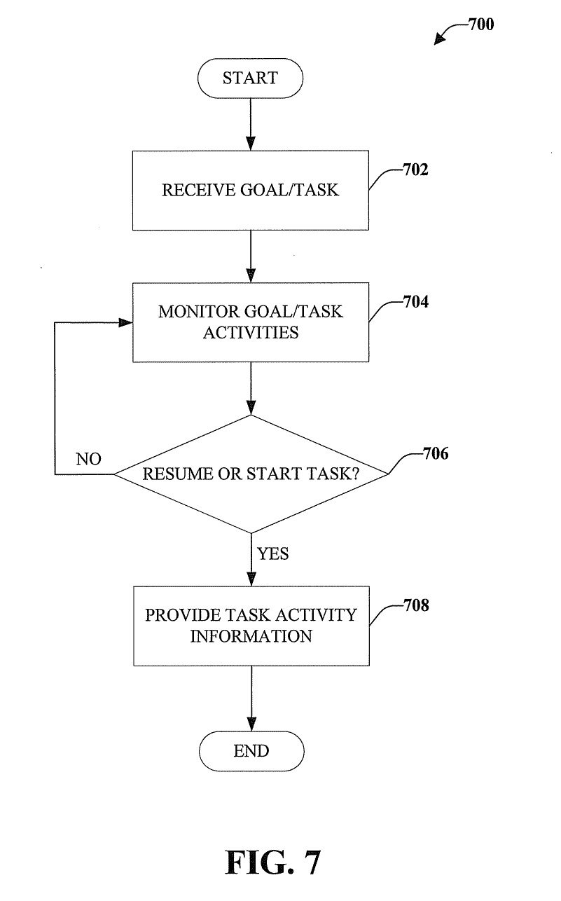

FIG. 7 illustrates a methodology 700 for facilitating resumption or the start of a task. At 702, a goal or task is received and can include a ranking or priority listing. At 704, the goal or task is monitored and compared to activities being performed by a user. A determination is made, at 706, whether a particular goal or task should be started or resumed (if already started). Such a determination can be made based on priority information, due date information, or other criteria. For example, the determination can be made based on an estimate of the completion time for the task or for each task that should be performed to reach a goal. Based on the amount of time for each task and the due date for the task/goal, a determination can be made that the task/goal should be started so that it might be completed by the due date.

If the determination, at 706, is that the task does not need to be resumed or started, method 700 can return to 704 with monitoring of activities and progress of a goal or task. If the determination is that the task should be resumed or started, task activity information can be provided, at 708. Such information can include an indication of a particular placement within the workflow process. This can include the steps that are finished, the next step to be performed, and the remaining steps needed to finish the task. Such information can make it easier for the user to resume the activity.

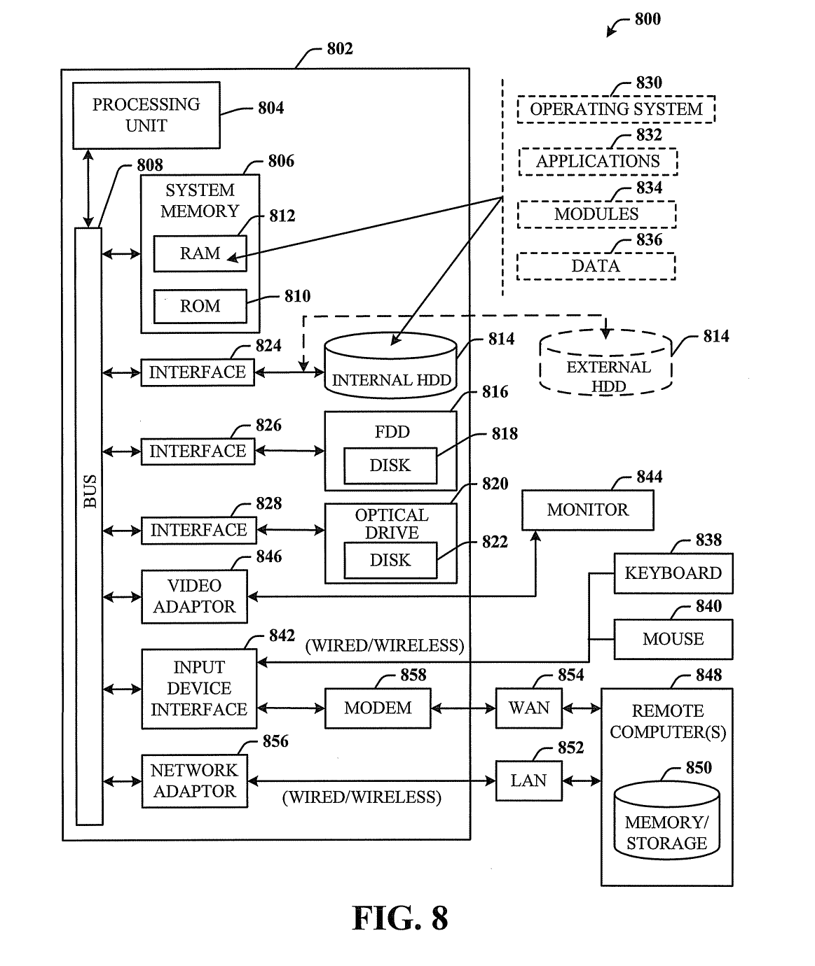

Referring now to FIG. 8, there is illustrated a block diagram of a computer operable to execute the disclosed architecture. In order to provide additional context for various aspects disclosed herein, FIG. 8 and the following discussion are intended to provide a brief, general description of a suitable computing environment 800 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the various embodiments can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 through an interface, such as a video adapter 846. In addition to the monitor 844, a computer typically includes other peripheral output devices (not shown), such as speakers, printers, etc.

The computer 802 may operate in a networked environment using logical connections through wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 through the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

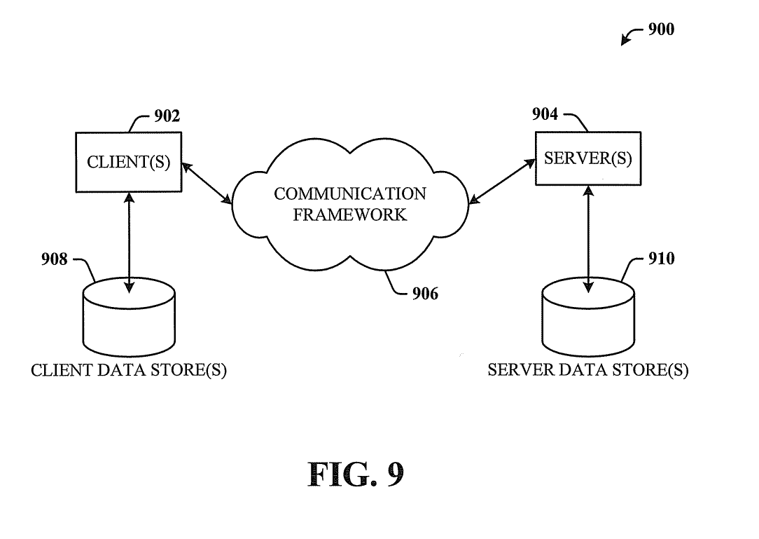

Referring now to FIG. 9, there is illustrated a schematic block diagram of an exemplary computing environment 900 in accordance with the various embodiments. The system 900 includes one or more client(s) 902. The client(s) 902 can be hardware and/or software (e.g., threads, processes, computing devices). The client(s) 902 can house cookie(s) and/or associated contextual information by employing the various embodiments, for example.

The system 900 also includes one or more server(s) 904. The server(s) 904 can also be hardware and/or software (e.g., threads, processes, computing devices). The servers 904 can house threads to perform transformations by employing the various embodiments, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated through a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed embodiments.

Various embodiments have been presented in terms of systems that may include a number of components, modules, and the like. It is to be understood and appreciated that the various systems may include additional components, modules, etc. and/or may not include all of the components, module etc. discussed in connection with the figures. A combination of these approaches may also be used. The various embodiments disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates user introspection, comprising:
a monitoring component that monitors a user activity; and
an introspection component that provides a feedback based at least in part on the monitored activity.

2. The system of claim 1, the introspection component provides a feedback based in part on at least one of a profile information and a defined goal.

3. The system of claim 2, the profile information is at least one of a user profile, an activity profile, an organizational profile, and a device profile.

4. The system of claim 1, the feedback comprising information about time spent on activities that are not related to a defined goal.

5. The system of claim 1, the feedback is at least one of a real-time feedback and a reporting mechanism.

6. The system of claim 1, further comprising a behavior detection component that detects at least one of an avoidance of an activity and a thrashing behavior and notifies the introspection component of the avoided activity or thrashing behavior.

7. The system of claim 6, further comprising a ranking component that ranks a goal based in part on the avoidance of an activity or a thrashing behavior.

8. The system of claim 1, the introspection component receives user feedback and adjusts a ranking based on the received user feedback.

9. The system of claim 1, further comprising an activity resumption component that provides information about at least one of task reacquisition and goal reminder.

10. The system of claim 9, the activity resumption component provides the user a recommended task to facilitate resumption of an activity

11. The system of claim 9, the activity resumption component reminds the user of at least one of a last task(s) completed, a time already spent on the activity, a time spent on each particular portion of the task, a context for the task, and a reason why the task is important.

12. A computer-implemented method of providing completion of user defined goals, comprising:
receiving a at least one defined goal;
monitoring activity of a user;
comparing the monitored activity to the defined goal; and
providing a recommendation to the user based in part on the comparison between the monitored activity and the defined goal.

13. The method of claim 12, the recommendation is at least one of a task reacquisition and a goal reminder.

14. The method of claim 12, the recommendation is provided based on a user query.

15. The method of claim 12, the recommendation is based on a task priority.

16. The method of claim 12, the recommendation is at least one of a best next action and a worst next action.

17. The method of claim 12, comparing the monitored activity to the defined goal further comprising utilizing a profile information to facilitate the comparison, the profile information is at least one of a user profile, an activity profile, an organizational profile, and a device profile.

18. A system that facilitates goal accomplishment through introspection, comprising
means for receiving at least one user-defined goal;
means for monitoring at least one activity;
means for determining if the at least one monitored activity is related to the at least one user-defined goal; and
means for providing the user with status of the at least one user-defined goal based in part on a relationship between the at least one monitored activity and the at least one user-defined goal.

19. The system of claim 18, further comprising means for recommending a next action based in part on the status of the at least one user-defined goal.

20. The system of claim 18, further comprising means for altering a priority of the at least one user-defined goal based in part on a pattern of activity avoidance.
